(19) United States
(12) Patent Application Publication
(10) Pub. No.: US 2025/0376050 A1
(43) Pub. Date: Dec. 11, 2025

(54) CONNECTOR RETENTION SYSTEM OF AN ENERGY TRANSFER SYSTEM

(71) Applicant: Caterpillar Inc., Peoria, IL (US)

(72) Inventors: Matthew SHERWOOD, Christchurch (NZ); Elliot MOSS, Christchurch (NZ)

(73) Assignee: Caterpillar Inc., Peoria, IL (US)

(21) Appl. No.: 18/736,177

(22) Filed: Jun. 6, 2024

(51) Int. Cl. B60L 53/16; B60L 53/37

(52) U.S. Cl. CPC B60L 53/16; B60L 53/37; B60L 2200/40

(57) ABSTRACT

An energy transfer system includes a robotic system and a connector retention system that includes an end effector for enabling an energy transfer to a work machine via a receptacle access point of the work machine, wherein the energy transfer is to occur when one or more plugs of the end effector are coupled to one or more receptacles of the receptacle access point. The connector retention system is mounted on the end effector of the robotic system and is configured to enable coupling between the one or more plugs and the one or more receptacles. The connector retention system includes a compliance system for providing multi-axis alignment flexibility for the one or more plugs to facilitate coupling of the one or more plugs to the one or more receptacles, and includes a first end component, a second end component, a middle component, and a plurality of flexible connectors.

### TECHNICAL FIELD

The present disclosure relates generally to a connector retention system and, for example, to a connector retention system for an energy transfer system.

### BACKGROUND

Machines (e.g., that utilize an energy source other than fossil fuel, such as electricity, hydrogen, methanol, ammonia, or other sources of energy), such as vehicles or other mobile machines, that are at least partially powered by on-board energy storage systems (e.g., batteries, hydrogen fuel cells, chemical storage components, among other examples) can be environmentally-friendly alternatives to machines powered by fossil fuels. In many cases, such a machine includes an energy transfer interface that can be physically connected to an energy transfer system to allow an energy transfer from the energy transfer system to an on-board energy storage system of the machine (e.g., to replenish the on-board energy storage system). The energy transfer interface can include a connector, such as a receptacle, that is configured to couple to a corresponding connector, such as a plug, of the energy transfer system to enable the energy transfer.

In some cases, due to tolerance issues associated with manufacturing and assembly of the energy transfer interface and of the energy transfer system, it may be difficult to couple the connector (e.g., the receptacle) of the energy transfer interface to the connector (e.g., the plug) of the energy transfer system (e.g., because the respective geometries of the connectors may not optimally correspond to each other). Further, when the energy transfer system includes a system to facilitate coupling of the connectors, a likelihood of misalignment of the connectors (e.g., due the tolerance issues) is increased. Each scenario can lead to a sub-optimal coupling of the connectors, which results in a sub-optimal replenishment of the on-board energy storage system for the machine, such as in terms of an increased amount of time needed to replenish the energy for the machine and a decreased available energy level on-board the machine. Additionally, sub-optimal replenishment can impact operations of a machine, such as by reducing an amount of time that the machine is available to perform powered operations (e.g., as compared to an amount of time that the machine needs to be replenished with energy) and by reducing an amount of power that is available to perform the powered operations. Sub-optimal replenishment of the on-board energy storage system for the machine can, in some cases, also degrade the on-board energy storage system of the machine, which impacts a performance and an operable life of the on-board energy storage system, and of the machine.

U.S. Patent Application Publication No. US2023/056007 (the '007 publication) discloses a self-aligning electrical connector system for data and/or energy transmission. According to the '007 publication, a first connector part further includes positioning pins and a second connector part further includes positioning chambers, the positioning pins being engageable in the positioning chambers to achieve rough positioning of the first and second connector parts relative to one another. The '007 publication further elaborates that the first connector part being floatingly arranged on a support frame with three rotational and at least two translational degrees of freedom, where the first connector part is supported on the support frame by spring forces of spring arms acting on flat elements and being supported on a ball with the ball being rollable on a central bar whereby the first connector part is floatingly arranged on the support frame and is shiftable and tiltable relative to the support frame. Additionally, a bearing of the first connector part on the ball and the spring arms of the support frame allows translational movements of the first connector part in the x and y directions, tilting movements about the x and y axes, and rotational movements about the z axis. The amplitude of the tilting movements is limited by delimiting braces, which act as stops. To limit the amplitude of rotational movements about the z axis, a vertically protruding stop element is formed on a central bar of the support frame.

While the '007 publication discloses a self-aligning electrical connector system for data and/or energy transmission, the self-aligning electrical connector system is complex. For example, the self-aligning electrical connector system uses multiple types of components, such as a ball, spring arms, delimiting braces, a stop element, and other components to allow and to limit translation movements and tilting movements. Such complexity introduces multiple points of failure, which can lead to system malfunctions and downtime. Any malfunction of the self-aligning electrical connector system (e.g., that negatively impacts translation movements and tilting movements of the self-aligning electrical connector system) can result in contact damage to high-load contact elements and low-load connectors of the self-aligning electrical connector system (e.g., when the self-aligning electrical connector system does not move as intended).

The connector retention system of the present disclosure solves one or more of the problems set forth above and/or other problems in the art.

### SUMMARY

In some implementations, an energy transfer system comprises: a robotic system that includes an end effector for enabling an energy transfer to a work machine via a receptacle access point of the work machine, wherein the energy transfer is to occur when one or more plugs of the end effector are coupled to one or more receptacles included in the receptacle access point; and a connector retention system mounted on the end effector of the robotic system for enabling coupling between the one or more plugs and the one or more receptacles, wherein the connector retention system includes a compliance system for providing multi-axis alignment flexibility for the one or more plugs to facilitate coupling of the one or more plugs to the one or more receptacles, and wherein the compliance system includes a first end component, a second end component, a middle component, and a plurality of flexible connectors.

In some implementations, an end effector of a robotic system includes a connector retention system for enabling coupling between one or more plugs of the end effector and one or more receptacles included in a receptacle access point, wherein the connector retention system includes a compliance system for providing multi-axis alignment flexibility for the one or more plugs, and wherein the compliance system includes a first end component, a second end component, one or more middle components, and a plurality of flexible connectors.

In some implementations, a connector retention system of an end effector of a robotic system includes a first end component; a second end component; one or more middle components; and a plurality of flexible connectors, wherein: the first end component, the second end component, the one or more middle components, and the plurality of flexible connectors provide multi-axis alignment flexibility for a plug of the end effector.

### BRIEF DESCRIPTION OF THE DRAWINGS

FIG. 1 is a diagram of an example work machine.

FIGS. 2A-2B are diagrams of examples of a receptacle access point.

FIGS. 3A-3B are diagrams of an example energy transfer system.

FIGS. 4A-4B are diagrams of examples of an end effector of a robotic system of an energy transfer system.

FIGS. 5A-5E are diagrams of examples associated with a connector retention system of an energy transfer system.

### DETAILED DESCRIPTION

This disclosure relates to a connector protection system of an energy transfer system that is configured to enable an energy transfer to a work machine, which is applicable to any work machine that is at least partially powered by a non-fossil-fuel-based energy storage system. The work machine may be any type of machine configured to perform operations associated with an industry such as mining, construction, farming, transportation, or any other industry.

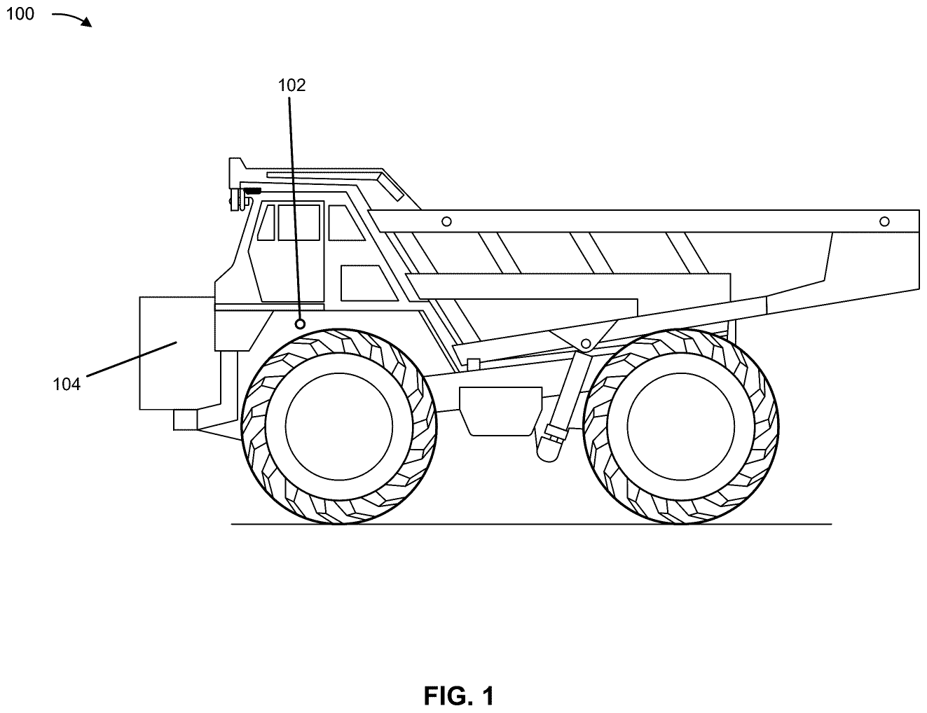

FIG. 1 is a diagram (e.g., a side-view) of an example work machine 100 described herein. The work machine 100 may be a mobile machine or vehicle, and may include a dump truck, a wheel loader, a hydraulic excavator, or another type of machine. Further, the work machine 100 may be a manned machine or an unmanned machine. The work machine 100 may be fully-autonomous, semi-autonomous, or remotely operated. As further shown in FIG. 1, the work machine 100 may include an energy storage system102 (e.g., included within a chassis of the work machine 100) and a receptacle access point 104.

The work machine 100 may be configured to be at least partially powered by the energy storage system 102. That is, the work machine may be a machine that utilizes electricity, hydrogen, methanol, ammonia, or other sources of energy other than a fossil fuel. As a specific example, when the energy storage system 102 includes a battery that stores electricity, the work machine 100 may be a battery electric machine (BEM), a battery electric vehicle (BEV), a hybrid vehicle, a fuel cell and battery hybrid vehicle, or another machine that is at least partially powered by the battery of the energy storage system 102. The work machine 100 may include one or more engines, one or more motors, one or more conversion systems, and/or other components that are configured to convert and/or use energy stored in the energy storage system 102, to cause overall movement of the work machine 100 across a work site and/or to cause movement of individual components or systems of the work machine 100.

The receptacle access point 104 provides an energy transfer interface (e.g., a physical energy transfer interface) for the energy storage system 102. For example, the receptacle access point 104 provides an energy transfer interface that can be physically connected to an energy transfer system (e.g., the energy transfer system 300 described herein) to allow an energy transfer from the energy transfer system to the energy storage system 102 (or vice versa). The receptacle access point 104 may be located on a front of the work machine 100 (as shown), a side of the work machine 100, a back of the work machine 100, a bottom of the work machine 100, a top of the work machine 100, or at any other position on the work machine 100. The receptacle access point 104 is further described herein.

As indicated above, FIG. 1 is provided as an example. Other examples may differ from what is described in connection with FIG. 1.

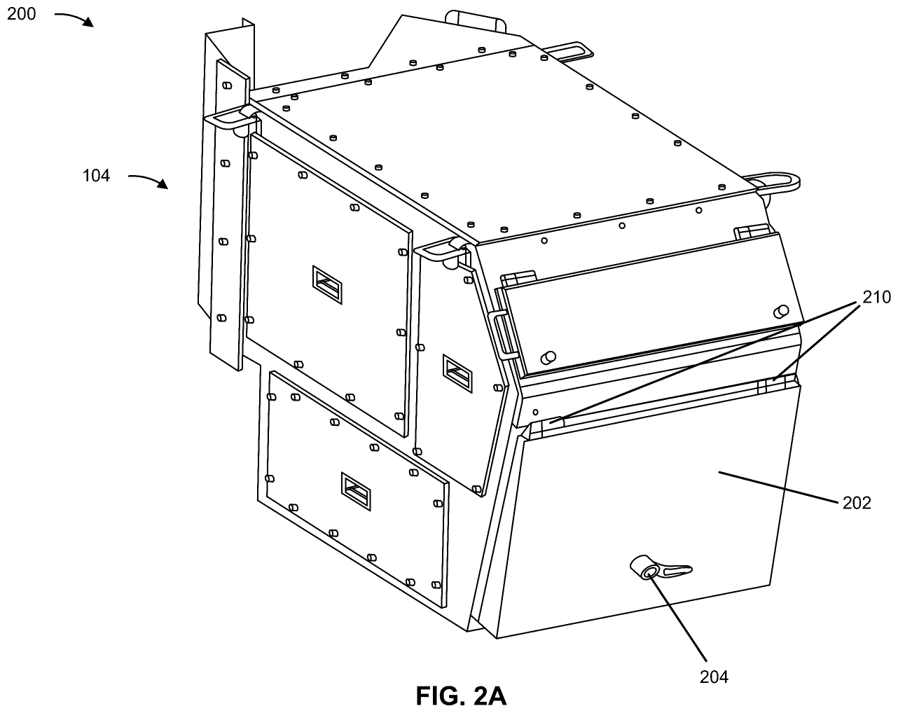

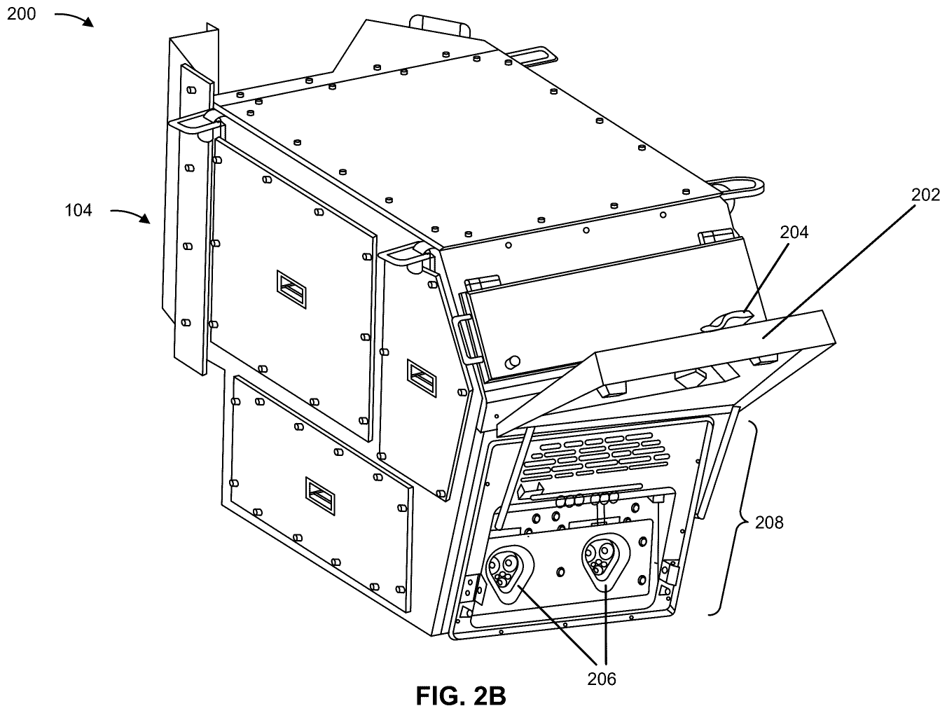

FIGS. 2A-2B are diagrams (e.g., front-angled views) of examples 200 of the receptacle access point 104 described herein. As shown in FIGS. 2A-2B, the receptacle access point 104 includes an access door 202, an access mechanism 204, and one or more receptacles 206. FIG. 2A shows the receptacle access point 104 in a closed state (e.g., when the access door 202 is in a closed position), and FIG. 2B shows the receptacle access point 104 in an open state (e.g., when the access door 202 is in an open position).

The access door 202 comprises a metal, or other hard and/or weather resistant material, and is configured to protect internal components of the receptacle access point 104, such as an interior panel 208 of the receptacle access point 104, when in the closed position. For example, when the access door 202 is in the closed position (e.g., such that edges of the access door 202 cover a flange of the interior panel 208) the access door 202 may prevent dirt, rocks, construction debris, waste matter, moisture, or other material (e.g., present at a work site at which the work machine 100 is operating) from accessing the interior panel 208. The access door 202 is moveable. For example, the access door 202 may be moved from the closed position (e.g., shown in FIG. 2A) to the open position (e.g., shown in FIG. 2B), such as by causing the access door 202 to pivot on one or more hinges 210.

The access mechanism 204 may be located on the access door 202, as shown in FIGS. 2A-2B, or may be located at any other position on the receptacle access point 104. The access mechanism 204 is configured to allow the access door 202 to open (e.g., to allow the access door 202 to move from the closed position to the open position and/or to remain at the open position) when the access mechanism 204 is disengaged. Further, the access mechanism 204 is configured to allow the access door 202 to remain closed (e.g., to remain in the closed position) when the access mechanism is engaged (e.g., after the access door 202 is moved to the closed position). That is, the access mechanism 204 may “lock” the access door 202 in the closed position when engaged, and may “unlock” the access door 202 to allow the access door 202 to move to the open position when disengaged.

The access mechanism 204 is configured to be manipulatable to cause the access mechanism 204 to be engaged (e.g., to change from disengaged to engaged) or to be disengaged (e.g., to change from engaged to disengaged). For example, the access mechanism 204 may be configured to be rotated, slid, pushed, pulled, lifted, extended, and/or retracted, among other examples, to cause the access mechanism 204 to be engaged or disengaged. Accordingly, the access mechanism 204 may include a latch, a bolt, a catch, a hook, a hasp, and/or a fastener, among other examples.

As shown in FIG. 2B, the one or more receptacles 206 may be included on the interior panel 208 of the receptacle access point 104. Each of the one or more receptacles 206 may be any type of physical component for coupling to a plug of an energy transfer system (e.g., a plug 402 of the energy transfer system 300 described herein) to enable an energy transfer from the energy transfer device to the energy storage system 102 (or vice versa). While the term “receptacles” are used herein, the one or more receptacles 206 may include plugs, ports, connectors, or any other type of physical energy transfer component.

As indicated above, FIGS. 2A-2B are provided as an example. Other examples may differ from what is described in connection with FIGS. 2A-2B.

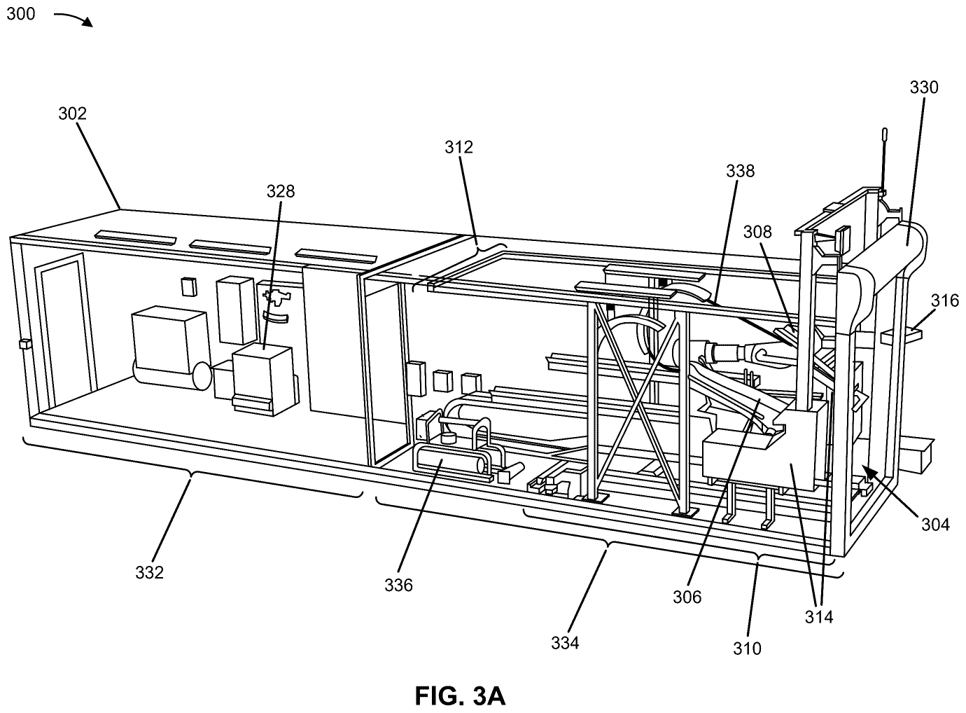

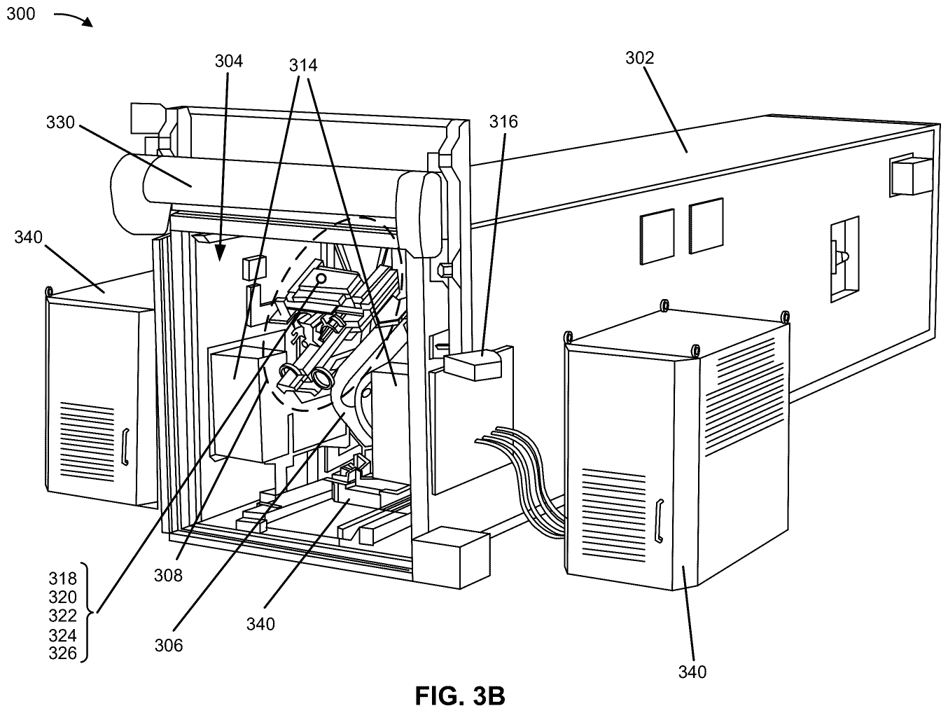

FIGS. 3A-3B are diagrams of an example energy transfer system 300. The energy transfer system 300 is configured to enable an energy transfer to and/or from the work machine 100 (e.g., to and/or from the energy storage system 102 of the work machine 100). In some implementations, the energy transfer system 300 is configured to autonomously enable the energy transfer (e.g., as further described herein), such as without any interaction with a human technician. However, other implementations include a human technician interacting with the energy transfer system 300 and, thus, the term “energy transfer system” includes any energy transfer system that is not autonomous, that is semi-autonomous (e.g., includes at least one autonomously controlled or operated system or component), or that is fully autonomous. FIG. 3A shows a side (cut-away) view of the energy transfer system 300, and FIG. 3B shows a front-angled view of the energy transfer system 300.

As shown in FIGS. 3A-3B, the energy transfer system 300 may include a housing 302 that includes a portal 304 at an end of the housing; a robotic system 306 that includes an end effector 308; a slide system 310; a cable management system 312; an energy transfer outlet system 314; a first camera system 316; a second camera system 318; a door opening system 320; a connector retention system 322; a connector protection system 324; a door closing system 326; and/or one or more controllers 328.

The housing 302 comprises a metal, or other hard and/or weather resistant material, and may have a rectangular prism shape. For example, the housing 302, may have a similar size and/or dimensions of a shipping container (e.g., with four “long” sides and two “short” sides). The housing 302 may include the portal 304 at an end of the housing 302 (e.g., instead of one of the short sides of the housing 302). The energy transfer system 300 may include an access door 330 that is configured to cover the portal 304 when closed, and to uncover the portal 304 when open. For example, the access door 330 may be a retractable door. The access door 330, when closed, may protect an interior of the housing 302, such by preventing dirt, rocks, construction debris, waste matter, moisture, or other material (e.g., present at a work site at which the work machine 100 is operating) from accessing interior of the housing 302.

As shown in FIG. 3A, the interior of the housing 302 may be divided into a first interior portion 332 of the housing 302 and a second interior portion 334 of the housing 302 (e.g., that is separated by a wall, a door, or another separator). The first interior portion 332 of the housing 302 may include the one or more controllers 328 and/or one or more other electrical components, one or more pneumatic components, and/or one or more other communication components, among other examples, that enable operation of the systems and components included in the second interior portion 334 of the housing 302.

The second interior portion 334 of the housing 302 may include the slide system 310, the cable management system 312, and the energy transfer outlet system 314. The second interior portion 334 may also include additional systems and/or components for enabling operation of the robotic system 306 and/or an energy transfer operation, such as a pressure washer system 336 and one or more energy transfer cables 338 (e.g., that are configured to transmit energy to and/or from one or more plugs of the end effector 308, such as the one or more plugs 402 described herein).

The slide system 310 is configured to move the robotic system 306, via the portal 304 of the housing 302, between an interior of the housing 302 (e.g., the second interior portion 334 of the housing 302) and an external environment (e.g., that surrounds the housing 302, such as at a work site). The cable management system 312 is configured to provide management of the one or more energy transfer cables 338. The energy transfer outlet system 314 is configured to enable a connection between the one or more energy transfer cables 338 and an external transfer dispenser system 340 (e.g., that is not included in the energy transfer system 300). Accordingly, the external transfer dispenser system 340 may provide energy to the one or more energy transfer cables 338, and thus to plugs of the end effector (e.g., the plugs 402 described herein) via the energy transfer outlet system 314.

As shown in FIGS. 3A-3B, the first camera system 316 may be mounted on an exterior (e.g., an exterior side) of the housing 302. The first camera system 316 is configured to obtain first image data associated with the receptacle access point 104 (e.g., when mounted on the work machine 100). For example, the first camera system 316 may obtain the first image data to allow the one or more controllers 328 to determine whether the receptacle access point 104 is within an engagement range of the robotic system 306 (e.g., when the robotic system 306 is moved to the external environment by the slide system 310), such as to allow the robotic system 306 to interact with the receptacle access point 104 to initiate an energy transfer operation.

As shown in FIG. 3A, the second interior portion 334 of the housing 302 may include the robotic system 306 (e.g., mounted to the slide system 310), such as when the robotic system 306 been moved to the interior of the housing 302 by the slide system 310. The robotic system 306 is configured to enable an energy transfer to or from the work machine 100 (e.g., to or from the energy storage system 102 of the work machine 100), such as when the robotic system 306 been moved to the external environment by the slide system 310.

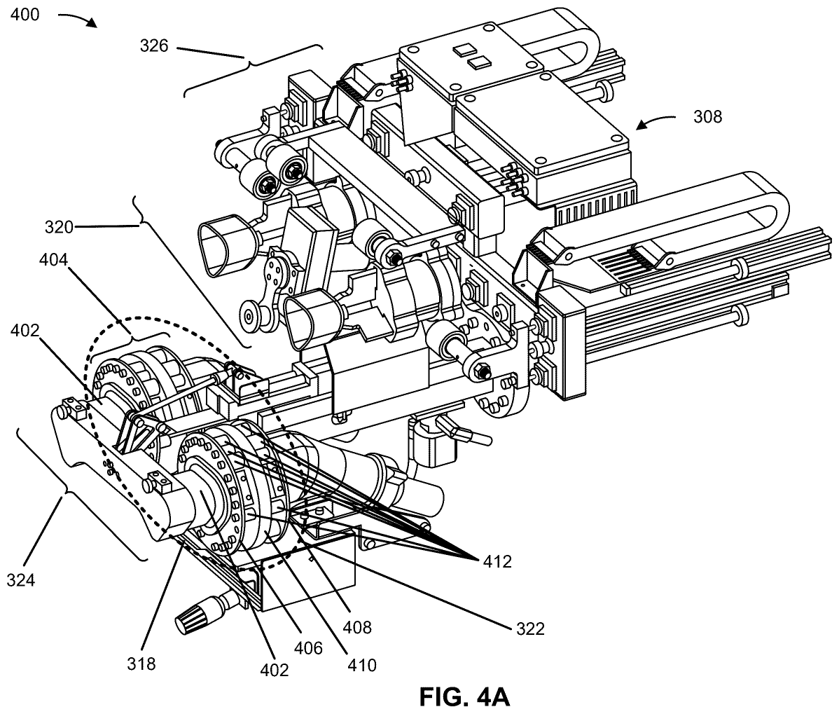

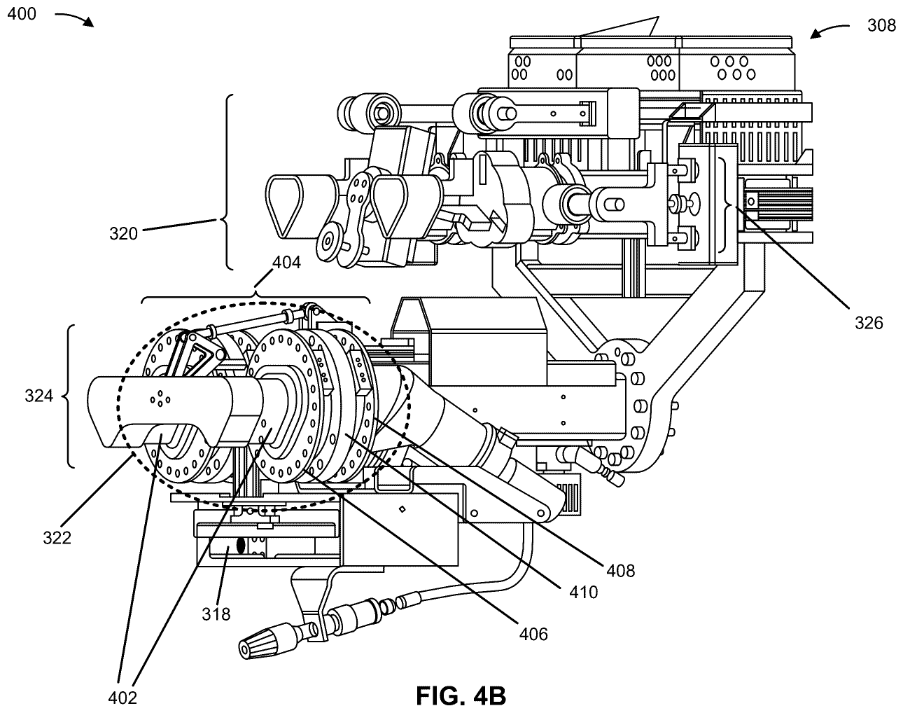

Accordingly, the robotic system includes the end effector 308, which may include (e.g., mounted to the end effector 308) the second camera system 318, the door opening system 320, the connector retention system 322, the connector protection system 324, and/or the door closing system 326. As the illustration of the end effector 308 is too small in FIGS. 3A-3B to clearly depict the second camera system 318, the door opening system 320, the connector retention system 322, the connector protection system 324, and/or the door closing system 326, these systems and the end effector 308 are shown in greater detail in FIGS. 4A-4B.

The second camera system 318 is configured to obtain second image data associated with the access mechanism 204 of the receptacle access point 104. For example, the second camera system 318 may obtain the second image data to allow the one or more controllers 328 to identify a location of the access mechanism 204 of the receptacle access point 104, such as to allow the door opening system 320 to open the access door 202 of the receptacle access point 104. Further, the second camera system 318 is configured to obtain third image data associated with the one or more receptacles 206 included in the receptacle access point 104, such as to allow the one or more controllers 328 to identify a location of the one or more receptacles 206 and therefore enable one or more plugs of the end effector 308 (e.g., the one or more plugs 402 of the end effector 308 further described herein) to couple to the one or more receptacles 206 and thereby enable the energy transfer operation.

The door opening system 320 is configured to open the access door 202 of the receptacle access point 104 (e.g., based on the location of the access mechanism 204 of the receptacle access point 104 identified by the one or more controllers 328). The door opening system 320 may include a manipulation system for manipulating the access mechanism 204 of the receptacle access point 104 to allow the access door 202 to open.

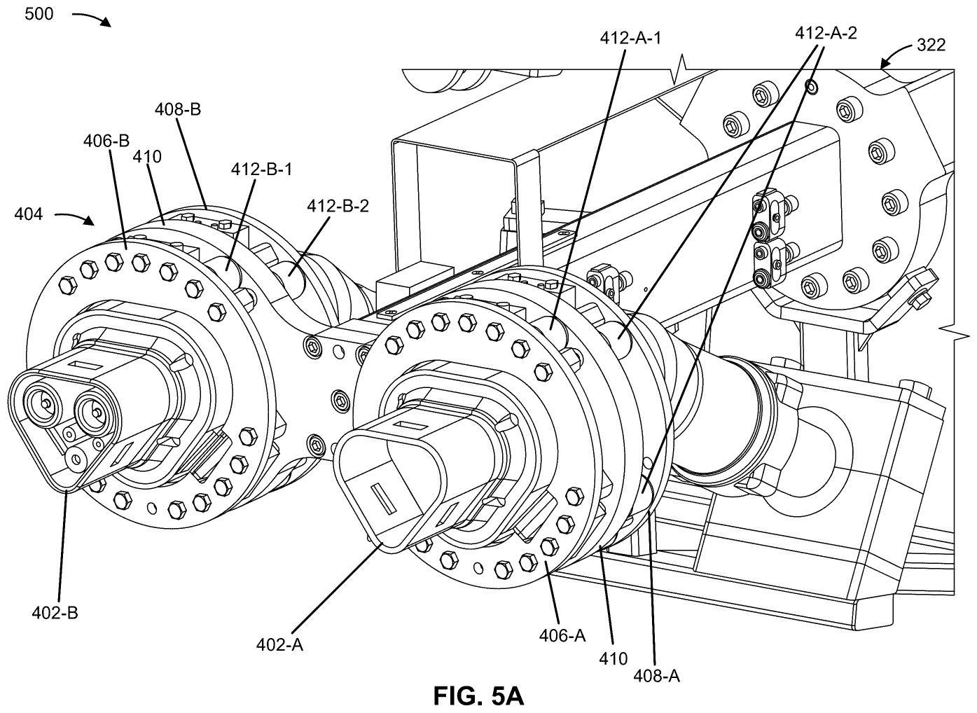

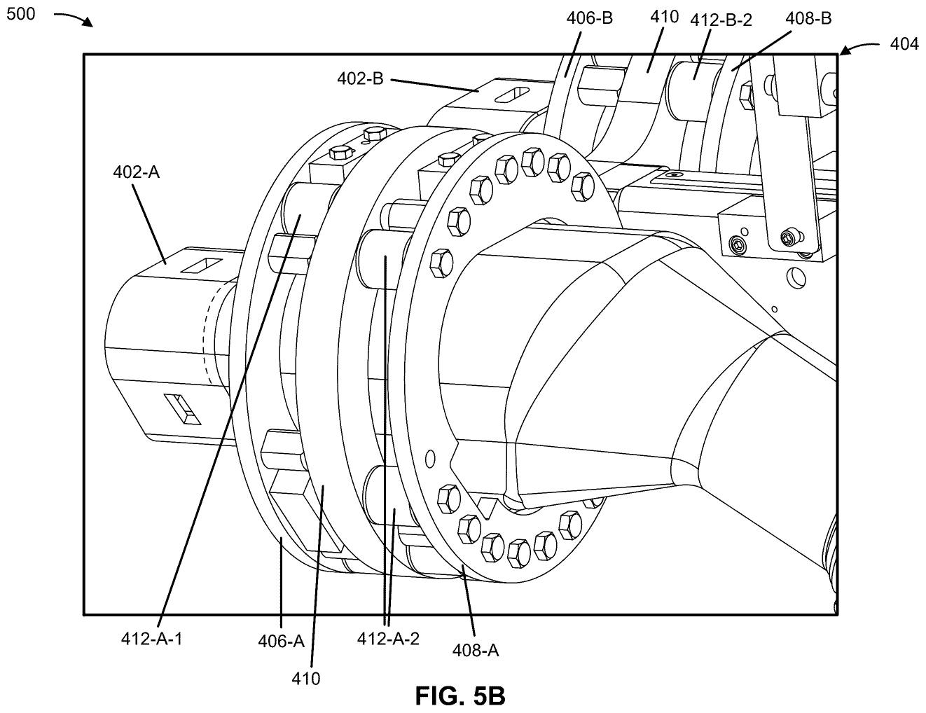

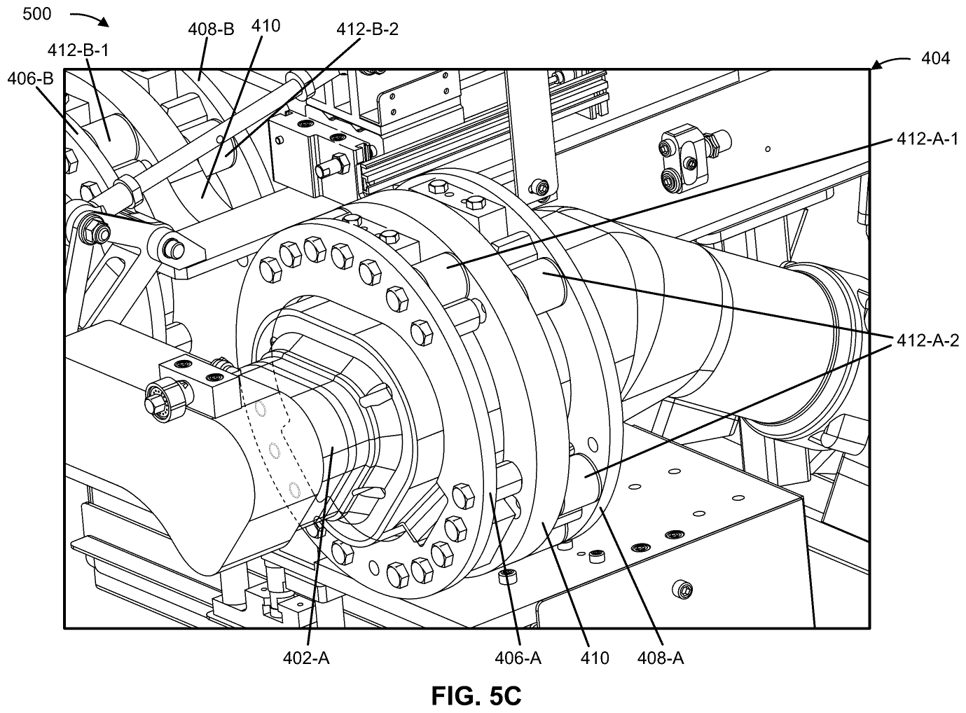

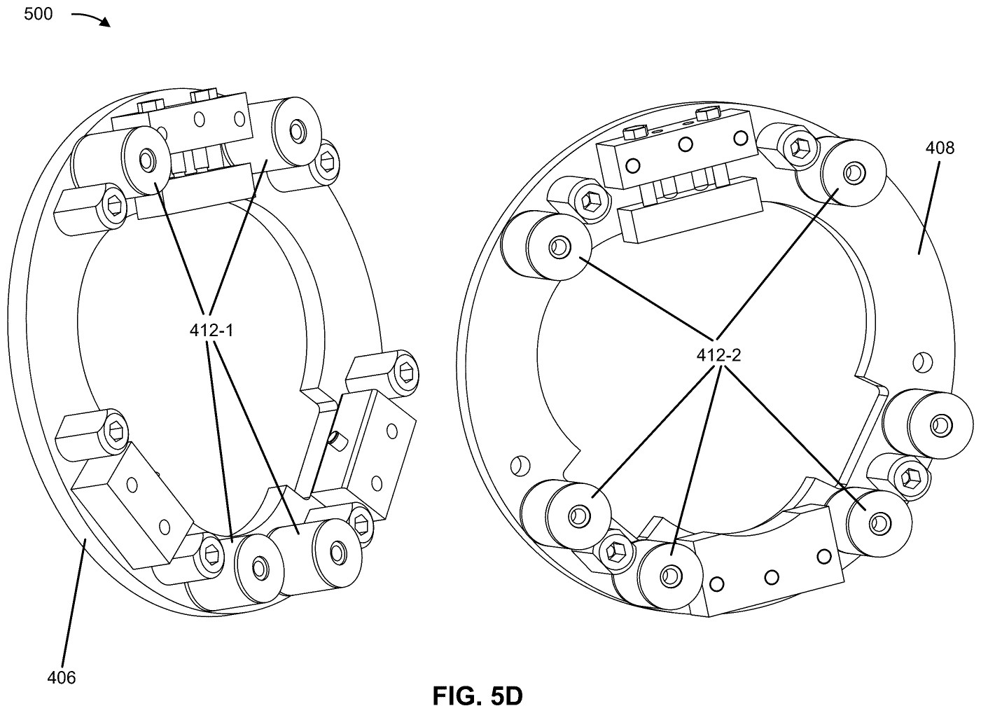

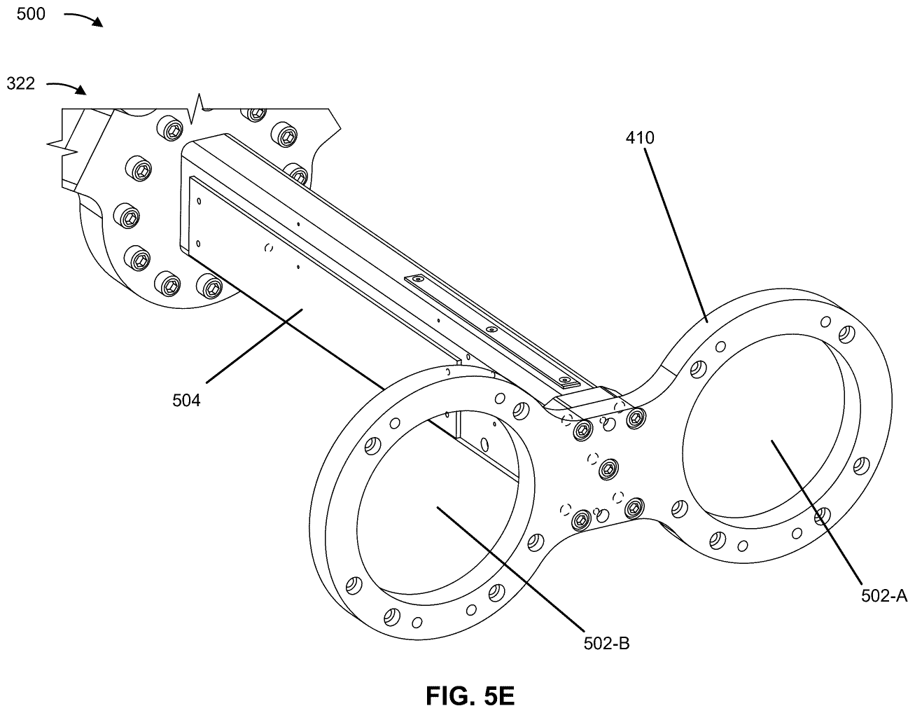

The connector retention system 322 is configured to enable coupling between the one or more plugs of the end effector 308 (e.g., the one or more plugs 402 of the end effector 308 further described herein) and the one or more receptacles 206 (e.g., to enable the energy transfer operation). The connector retention system 322 is further described herein in relation to FIGS. 4A-4B and 5A-5E.

The connector protection system 324 is configured to protect the one or more plugs of the end effector 308 (e.g., the one or more plugs 402 of the end effector 308 further described herein) when not coupled to the one or more receptacles 206. The connector protection system 324 may include a cap for covering the one or more plugs and a cap adjustment system for removing the cap (e.g., from the one or more plugs) and for replacing the cap (e.g., on the one or more plugs).

The door closing system 326 is configured to close the access door 202 of the receptacle access point 104 (e.g., after cessation of an energy transfer operation enabled by coupling of the one or more receptacles 206 to one or more plugs of the end effector 308).

As indicated above, FIGS. 3A-3B are provided as an example. Other examples may differ from what is described in connection with FIGS. 3A-3B.

FIGS. 4A-4B are diagrams of examples 400 of the end effector 308 of the robotic system 306 described herein. FIG. 4A shows a side-angled view of the end effector 308, and FIG. 4B shows a front-angled view of the end effector 308.

As shown in FIGS. 4A-4B, the end effector 308 includes one or more plugs 402. Each of the one or more plugs 402 may be any type of physical component for coupling to a corresponding receptacle 206 of the receptacle access point 104 to enable an energy transfer from the energy transfer system 300 to the work machine 100 (e.g., to the energy storage system 102 of the work machine 100) (or vice versa). Accordingly, the energy transfer is to occur when the one or more plugs 402 are coupled to the one or more receptacles 206 of the receptacle access point 104. While the term “plugs” are used herein, the one or more plugs 402 may include receptacles, ports, connectors, or any other type of physical energy transfer component.

As further shown in FIGS. 4A-4B, the end effector 308 may include (e.g., mounted to the end effector 308) the second camera system 318, the door opening system 320, the connector retention system 322, the connector protection system 324, and/or the door closing system 326. For example, as shown in FIGS. 3A-3B, the second camera system 318 may be positioned at a bottom of the end effector 308, the one or more plugs 402 may be positioned above the second camera system 318 (and the connector retention system 322 and the connector protection system 324 may be positioned in line with the one or more plugs 402), the door opening system 320 may be positioned above the one or more plugs 402, and the door closing system 326 may be positioned above the door opening system 320.

As shown in FIGS. 4A-4B, the connector retention system 322 may include a compliance system 404 for providing multi-axis alignment (e.g., for at least two of an x-axis, a y-axis, or a z-axis) flexibility for the one or more plugs 402 of the end effector 308, such as to facilitate coupling of the one or more plugs 402 to the one or more receptacles 206 of the receptacle access point 104. For example, the compliance system 404 may include, for a plug 402 of the end effector 308, a first end component 406, a second end component 408, one or more middle components 410, and a plurality of flexible connectors 412 (e.g., as further described herein in relation to FIGS. 5A-5E) that are configured to provide multi-axis alignment flexibility for the plug 402. Further details related to the first end component 406, the second end component 408, the one or more middle components 410, and the plurality of flexible connectors 412 of the compliance system 404 are described herein in relation to FIGS. 5A-5E.

As indicated above, FIGS. 4A-4B are provided as an example. Other examples may differ from what is described in connection with FIGS. 4A-4B.

FIGS. 5A-5E are diagrams of examples 500 associated with the connector retention system 322. FIG. 5A show an angled front view of the connector retention system 322; FIG. 5B shows a back-angled side view of the compliance system 404 (e.g., in association with a particular plug 402 of the one or more plugs 402 of the end effector 308); FIG. 5C shows a front-angled side view of the compliance system 404 (e.g., in association with the particular plug 402); FIG. 5D shows views of the first end component 406 and the second end component 408 of the compliance system 404 of the connector retention system 322; and FIG. 5E shows an example of an example middle component 410 of the compliance system 404.

As described elsewhere herein, the compliance system 404 may include the first end component 406, the second end component 408, the one or more middle components 410, and the plurality of flexible connectors 412. Notably, the first end component 406, the second end component 408, the one or more middle components 410, and the plurality of flexible connectors 412 may be associated with a particular plug 402 of the one or more plugs 402. For example, the first end component 406, the second end component 408, the one or more middle components 410, and the plurality of flexible connectors 412 may be disposed around (e.g., circumferentially surround, at least partially) the particular plug 402 (e.g., in a stack configuration). That is, the first end component 406 may be disposed around a first region of the plug 402, the one or more middle components 410 are disposed around respective second regions of the plug 402, and the second end component 408 may be disposed around a third region of the plug 402, where the first region is closer to an input end of the plug 402 than the second regions and the third region, and the third region is farther from the input end of the particular plug 402 than the first region and the second regions. While FIGS. 5A-5E show the first end component 406, the second end component 408, the one or more middle components 410 are shown as rings, each component may have another geometric configuration that allows for the component to be disposed around a region of the plug 402.

Additionally, each flexible connector 412, of the plurality of flexible connectors 412 may comprise an elastomeric material. In this way, the plurality of flexible connectors 412 provide an elasticity that allows the compliance system 404 to provide the multi-axis alignment flexibility described herein.

A flexible connector 412 may connect a particular middle component 410, of the one or more middle components 410, to one of the first end component 406, the second end component 408, or another middle component 410 component of the one or more middle components 410. Accordingly, when the compliance system 404 includes a single middle component 410, the plurality of flexible connectors 412 may include a first set of flexible connectors 412 (e.g., comprising at least one flexible connector 412) and a second set of flexible connectors 412 (e.g., comprising at least one flexible connector 412), where the first set of flexible connectors 412 connects the first end component 406 and the middle component 410 and the second set of flexible connectors 412 connects the second end component 408 and the middle component 410. Moreover, when the compliance system 404 includes one or more middle components 410, the first set of flexible connectors 412 may connect the first end component 406 and a particular middle component 410 of the one or more middle components 410, and the second set of flexible connectors 412 may connect the second end component 408 and the particular middle component 410, or another middle component 410, of the one or more middle components 410.

In some implementations, there may be more than one plug 402. Accordingly, the compliance system 404 may include another first end component 406, another second end component 408, and a plurality of other flexible connectors 412 for each additional plug 402. For example, FIGS. 5A-5C shows a particular configuration of the connector retention system 322 for when the end effector 308 includes two plugs 402. Accordingly, as shown in 5A, for a first plug 402-A, the compliance system 404 may include a first end component 406-A, a second end component 408-A, and a plurality of flexible connectors 412-A, and for a second plug 402-B, the compliance system 404 may include a first end component 406-B, a second end component 408-B, and a plurality of flexible connectors 412-B.

Notably, the one or more middle components 410 may be associated with each of the plugs 402. For example, as shown in FIGS. 5A-5C, a first portion of a (single) middle component 410 is associated with the first plug 402-A and a second portion of the middle component 410 is associated with the second plug 402-B. Accordingly, as shown in FIGS. 5A-5C, the first end component 406-A, the second end component 408-A, and the first portion of the middle component 410 may be disposed around the first plug 402-A (e.g., in a first stack configuration), and the first end component 406-B, the second end component 408-B, and the second portion of the middle component 410 may be disposed around the second plug 402-B (e.g., in a second stack configuration). More generally, when there are one or more middle components 410, the first end component 406-A, the second end component 408-A, and respective first portions of the one or more middle components 410 may be disposed around the first plug 402-A (e.g., in a first stack configuration), and the first end component 406-B, the second end component 408-B, and respective second portions of the one or more middle components 410 may be disposed around the second plug 402-B (e.g., in a second stack configuration).

Further, as shown in FIGS. 5A-5C, the plurality of flexible connectors 412-A may include a first set of flexible connectors 412-A-1 and a second set of flexible connectors 412-A-1, where the first set of flexible connectors 412-A-1 connects the first end component 406-A to the first portion of the middle component 410 and the second set of flexible connectors 412-A-2 connects the second end component 408-A and the first portion of middle component 410; and the plurality of flexible connectors 412-B may include a first set of flexible connectors 412-B-1 and a second set of flexible connectors 412-B-1, where the first set of flexible connectors 412-B-1 connects the first end component 406-B to the second portion of the middle component 410 and the second set of flexible connectors 412-B-2 connects the second end component 408-B and the first portion of middle component 410. More generally, when there are one or more middle components 410, a set of flexible connectors 412 may connect a portion of a particular middle component 410 and a corresponding portion of another middle component 410, a particular first end component 406, or a particular second end component 408.

FIG. 5D shows respective connecting surfaces of the first end component 406 and the second end component 408. As shown in FIG. 5D, the first end component 406 may include a first set of flexible connectors 412-1, along with other structural components for connecting the first end component 406 to a first region of a plug 402, positioned along a circumference of the first end component 406, and the second end component 408 may include a second set of flexible connectors 412-2, along with other structural components for connecting the second end component 408 to a second region of the plug 402, positioned along a circumference of the first end component 406 The positioning of the first set of flexible connectors 412-1 and of the second set of flexible connectors 412-2 may facilitate the compliance system 404 providing an optimal multi-axis alignment flexibility for the plug 402.

FIG. 5E shows an example of a middle component 410. As shown in FIG. 5E, the middle component 410 is a monolithic component. Further, the middle component 410 may include a hole 502 for each plug 402 of the one or more plugs 402 of the end effector 308. Accordingly, as shown in FIG. 5E, when the end effector 308 includes the first plug 402-A and second plug 402-B, the middle component 410 may include a first hole 502-A associated with the first plug 402-A (e.g., to allow a first portion of the middle component 410 to surround the first plug 402-A) and a second hole 502-B associated with the second plug 402-B (e.g., to allow a second portion of the middle component 410 to surround the second plug 402-B). Accordingly, when there are one or more middle components 410, each middle component 410 may be a monolithic component that may include a hole 502, associated with a respective portion of the middle component 410, for a corresponding plug 402.

As further shown in FIG. 5E, the middle component 410 is connected to a mounting component 504 of the connector retention system 322. The connector retention system 322 may include the mounting component 504 for mounting the connector retention system 322 to the end effector 308. Accordingly, when there are one or more middle components 410, at least one middle component 410 may be connected to the mounting component 504.

As indicated above, FIGS. 5A-5E are provided as an example. Other examples may differ from what is described in connection with FIGS. 5A-5E.

### INDUSTRIAL APPLICABILITY

The disclosed connector retention system enables providing multi-axis alignment flexibility for one or more plugs of an energy transfer system, such as when the one or more plugs are included in an end effector of a robotic system of the energy transfer system that is to facilitate coupling of the one or more plugs to one or more receptacles of a receptacle access point of a work machine. For example, the connector retention system allows each plug, of the one or more plugs, to move in at least two of an x-axis, a y-axis, or a z-axis.

The connector retention system may comprise a compliance system that includes a first end component, a second end component, one or more middle components, and a plurality of flexible connectors. The first end component, the second end component, and the one or more middle components are disposed around a particular plug of the one or more plugs of the energy transfer system. Each flexible connector comprise an elastomeric material, and connects a particular middle component to the first end component, the second end component, or another middle component of the one or more middle components. In this way, the compliance system provides, for the particular plug, a multi-level stack of ring components, where a set of flexible connectors are included in each level of the stack. Accordingly, due to the multi-level nature of the stack, a multi-axis alignment flexibility of the plug is increased (e.g., as compared to an arrangement with a single level of flexible connectors, or other types of components that enable translational or tilting movements). Further, due to the elastomeric nature of the flexible connectors and the multi-level nature of the stack, each level may be associated with a distinct multi-axis alignment flexibility, which provides a cumulative multi-axis alignment flexibility that cannot be otherwise provided using other types of components that enable translational or tilting movements.

When the energy system includes multiple plugs, the compliance system includes another first end component, another second end component, and a plurality of other flexible connectors for each additional plug. Additionally, the one or more middle components are associated with each of the plugs. Accordingly, for each plug, a corresponding first end component, corresponding respective portions of the one or more middle components, and a corresponding second end may be disposed around the plug, with respective sets of flexible connectors disposed between adjacent ring components. In this way, the compliance system provides, for each plug, a multi-level stack of ring components that provides a multi-axis alignment flexibility for the plug (e.g., that is independent of, or at least partially independent of, a multi-axis alignment flexibility provided for another plug).

In this way, by providing a multi-axis alignment flexibility for each plug, the disclosed connector retention system enables an optimal coupling of the one or more plugs of the energy transfer system to the one or more receptacles of the receptacle access point of the work machine. This therefore increase a likelihood of an optimal replenishment of an energy storage system of the work machine, such as in terms of decreasing an amount of time needed to replenish the energy storage system and in terms of enabling an increased replenishment level of the energy storage system (e.g., at, or near, a maximum replenishment level of the energy storage system). Optimal replenishment improves a performance of the work machine, such as by increasing an amount of time that the work machine is available to perform powered operations (e.g., as compared to an amount of time that the work machine needs to be replenished) and by increasing an amount of power that is available to perform the powered operations. Optimal replenishment of the electric machine also prevents, or minimizes a likelihood of, degradation of the energy storage system of the work machine, which improves a performance and/or operable life of the energy storage system, and the work machine.

What is claimed is:

1. An energy transfer system comprising:
a robotic system that includes an end effector for enabling an energy transfer to a work machine via a receptacle access point of the work machine,
wherein the energy transfer is to occur when one or more plugs of the end effector are coupled to one or more receptacles included in the receptacle access point; and
a connector retention system mounted on the end effector of the robotic system for enabling coupling between the one or more plugs and the one or more receptacles,
wherein the connector retention system includes a compliance system for providing multi-axis alignment flexibility for the one or more plugs to facilitate coupling of the one or more plugs to the one or more receptacles, and
wherein the compliance system includes a first end component, a second end component, a middle component, and a plurality of flexible connectors.

2. The energy transfer system of claim 1, wherein:
a first set of flexible connectors, of the plurality of flexible connectors, connects the first end component to the middle component; and
a second set of flexible connectors, of the plurality of flexible connectors, connects the second end component to the middle component.

3. The energy transfer system of claim 1, wherein the first end component, the second end component, and the middle component are disposed around a particular plug of the one or more plugs.

4. The energy transfer system of claim 1, wherein each flexible connector, of the plurality of flexible connectors, comprises an elastomeric material.

5. The energy transfer system of claim 1, wherein the connector retention system includes a mounting component for mounting the connector retention system to the end effector of the robotic system,
wherein the middle component is connected to the mounting component.

6. The energy transfer system of claim 1, wherein the compliance system further includes another first end component, another second end component, and a plurality of other flexible connectors.

7. The energy transfer system of claim 6, wherein:
a first set of flexible connectors, of the plurality of flexible connectors, connects the first end component and a first portion of the middle component;
a second set of flexible connectors, of the plurality of flexible connectors, connects the second end component and the first portion of the middle component;
a first set of other flexible connectors, of the plurality of other flexible connectors, connects the other first end component and a second portion of the middle component; and
a second set of other flexible connectors, of the plurality of other flexible connectors, connects the other second end component and the second portion of the middle component.

8. The energy transfer system of claim 6, wherein:
the first end component, the second end component, and a first portion of the middle component are disposed around a first plug of the one or more plugs; and
the other first end component, the other second end component, and a second portion of the middle component are disposed around a second plug of the one or more plugs.

9. The energy transfer system of claim 8, wherein the middle component is a monolithic component.

10. An end effector of a robotic system, comprising:
a connector retention system for enabling coupling between one or more plugs of the end effector and one or more receptacles included in a receptacle access point,
wherein the connector retention system includes a compliance system for providing multi-axis alignment flexibility for the one or more plugs, and
wherein the compliance system includes a first end component, a second end component, one or more middle components, and a plurality of flexible connectors.

11. The end effector of the robotic system of claim 10, wherein:
a first set of flexible connectors, of the plurality of flexible connectors, connects the first end component and a particular middle component of the one or more middle components; and
a second set of flexible connectors, of the plurality of flexible connectors, connects the second end component and the particular middle component, or another middle component, of the one or more middle components.

12. The end effector of the robotic system of claim 10, wherein:
the first end component, the second end component, and the one or more middle components are disposed around a particular plug of the one or more plugs.

13. The end effector of the robotic system of claim 10, wherein at least one of the one or more middle components is connected to mounting component of the connector retention system.

14. The end effector of the robotic system of claim 10, wherein the compliance system further includes another first end component, another second end component, and a plurality of other flexible connectors.

15. The end effector of the robotic system of claim 14, wherein:
the first end component, the second end component, and respective first portions of the one or more middle components are associated with a first plug of the one or more plugs; and
the other first end component, the other second end component, and respective second portions of the one or more middle components are associated with a second plug of the one or more plugs.

16. The end effector of the robotic system of claim 15, wherein each middle component, of the one or more middle components, is a monolithic component.

17. A connector retention system of an end effector of a robotic system, comprising:
a first end component;
a second end component;
one or more middle components; and
a plurality of flexible connectors, wherein:
the first end component, the second end component, the one or more middle components, and the plurality of flexible connectors provide multi-axis alignment flexibility for a plug of the end effector.

18. The connector retention system of claim 17, wherein the first end component, the second end component, and the one or more middle components are disposed around the plug.

19. The connector retention system of claim 17, wherein a flexible connector, of the plurality of flexible connectors, connects a particular middle component, of the one or more middle components, to one of:
the first end component;
the second end component; or
another middle component of the one or more middle components.

20. The connector retention system of claim 17, wherein each flexible connector, of the plurality of flexible connectors, comprises an elastomeric material.
